(19) United States
(12) Patent Application Publication
(10) Pub. No.: US 2012/0101878 A1
(43) Pub. Date: Apr. 26, 2012

(54) ADVERTISEMENT DISPLAY SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/110,930

(22) Filed: May 19, 2011

(30) Foreign Application Priority Data
Oct. 25, 2010 (TW) 99136240

(51) Int. Cl. G06Q 30/00

(52) U.S. Cl. 705/14.4

(57) ABSTRACT

In an advertisement display method implemented by an electronic device that installed with a three dimensional (3D) game, a default advertisement image of a product is displayed in a current scene of the 3D game when the 3D game is started or paused. A virtual object of the 3D game is displayed in the current scene of the 3D game, and movement of the virtual object is tracked when a user moves the virtual object in the current scene. A display orientation of the product is adjusted according to the movement of the virtual object until an advertising time of the product is elapsed.

### BACKGROUND

1. Technical Field

Embodiments of the present disclosure relate generally to advertisement displays, and more particularly, to an advertisement display system and an advertisement display method implemented by an electronic device.

2. Description of Related Art

Advertisements may be embedded in video games and visible to players between different levels in a game and sometimes even during game play. One advertisement display method displays a plurality of images of a product during game play in a three dimensional (3D) game at regular intervals. In the 3D game, player perspective may undergo great changes, however the advertisement method is not able to adjust to any changes in perspective and product placement may not be clearly visible to the player, and therefore not be effective.

### BRIEF DESCRIPTION OF THE DRAWINGS

FIG. 1 is a block diagram of one embodiment of an electronic device including an advertisement display system.

FIG. 2 is a schematic diagram illustrating one example of an advertisement image of a car is displayed in a current scene of a three dimensional (3D) game.

FIG. 3 a flowchart of one embodiment of an advertisement display method implemented in the electronic device of FIG. 1.

FIGS. 4A-4C are schematic diagrams illustrating one example of adjusting display orientation of the car according to user navigation through a virtual environment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

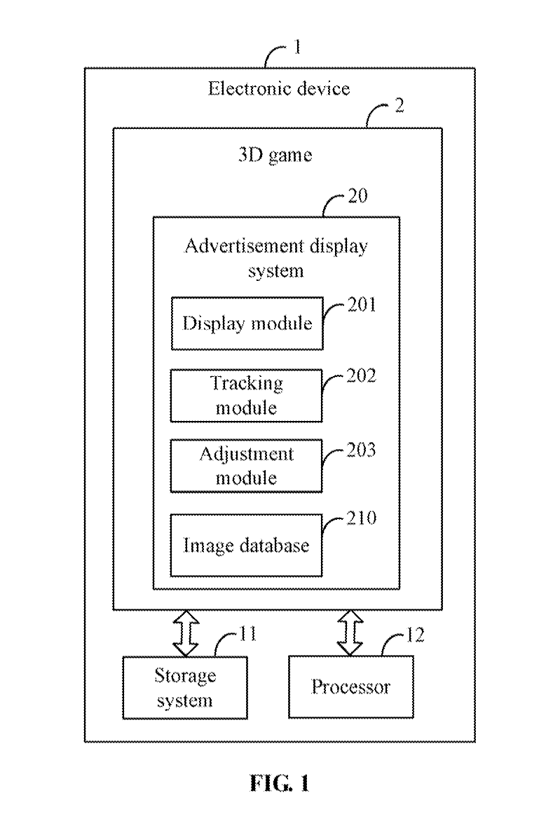

FIG. 1 is a block diagram of one embodiment of an electronic device 1 including an advertisement display system 20. In the embodiment, a three dimensional (3D) game 2 is installed in and played on the device 1. The 3D game 2 includes the advertisement display system 20 which may be active during game play of the 3D game 2. The device 1 further includes a storage system 11 and a processor 12. It should be apparent that FIG. 1 is only one example of the device 1 and that more or fewer components than shown may be included in other embodiments, or a different configuration of the various components. In one embodiment, the device 1 may be a computer, or a portable game player, for example.

The storage system 11 stores one or more programs, such as programs of an operating system, and other applications of the device 1. In one embodiment, the storage system 11 may be random access memory (RAM) for temporary storage of information, and/or a read only memory (ROM) for permanent storage of information. In other embodiments, the storage system 11 may also be an external storage device, such as a hard disk, a storage card, or a data storage medium. The processor 12 executes computerized operations of the device 1 and other applications, to provide functions of the device 1.

The advertisement display system 20 may include a plurality of functional modules comprising one or more computerized instructions that are stored in the storage system 11 or a computer-readable medium of the device 1, and executed by the processor 12 to perform operations of the device 1. In the embodiment, the advertisement display system 20 includes a display module 201, a tracking module 202, an adjustment module 203, and an image database 210. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

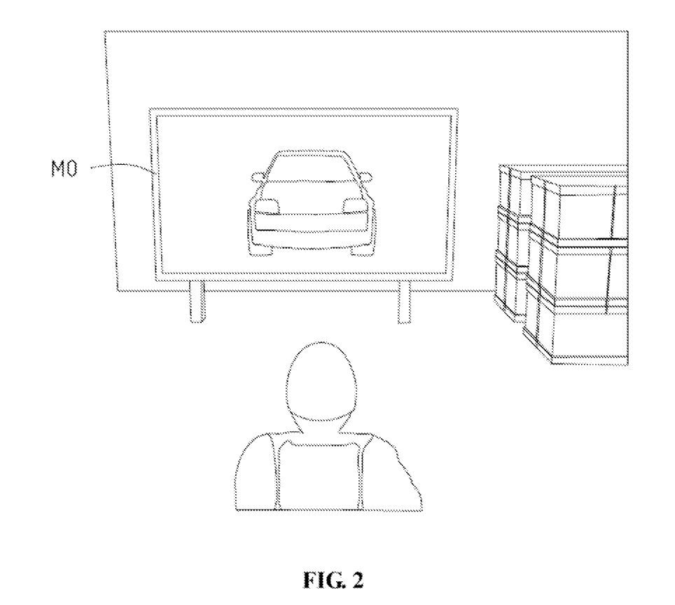

In the embodiment, a plurality of advertisement images of a product are stored in the image database 210, such as advertisement images of a car. The advertisement images may be oriented in different display orientations/perspectives based on a perspective of a user. The advertisement display system 20 can adjust the different display orientations of the product using the advertisement images of the image database 210 according to movement of a virtual object, such as an avatar, of the 3D game 2. As an example, referring to FIG. 2, the advertisement images are stored in the image database 210, and may be displayed on a virtual billboard MO of a current scene during game play. The advertisement images of the product may be pre-collected using a camera, and compressed to the image database 210. When the 3D game 2 is installed on the device 1, the compressed advertisement images may be uncompressed from the image database 210 to the storage system 11.

The display module 201 is operable to display a default advertisement image of the product to be advertised in a current scene of the 3D game 2 when the 3D game 2 is started or paused, and display a virtual object (e.g., an avatar) of the 3D game 2 in the current scene. In one embodiment, the default advertisement image may be obtained from the advertisement images of the image database 210. In other embodiments, the default image may be displayed in the current scene under other conditions, such as, when game play is over. Referring to FIG. 2, an avatar in use is a virtual soldier. When a default advertisement image of a car is displayed on the virtual billboard M0 of the current scene, the soldier may be displayed in front of the virtual billboard M0. The user may control the soldier to move in the current scene using an input device, such as, a mouse, a keyboard, or a joystick of the device 1.

The tracking module 202 is operable to track movement of the virtual object in the current scene in real-time when the user moves the virtual object in the current scene. In one embodiment, the movement of the virtual is tracked according to control signals input by the user using the input device.

The adjustment module 203 is operable to adjust a display orientation of the product according to the movement of the virtual object until an advertising time of the product is elapsed. In the embodiment, the display orientation of the product may be adjusted by selecting an advertisement image of the product from the image database 210 according to the movement of the virtual object, and then displaying the selected advertisement image in the current scene. A detailed description is provided as follows.

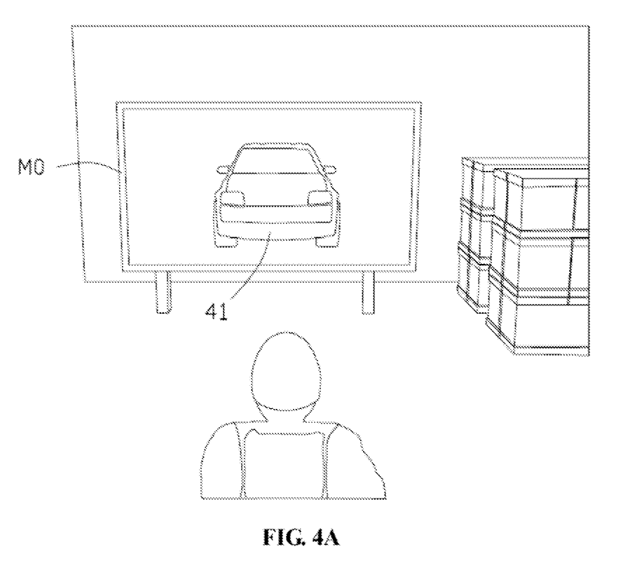

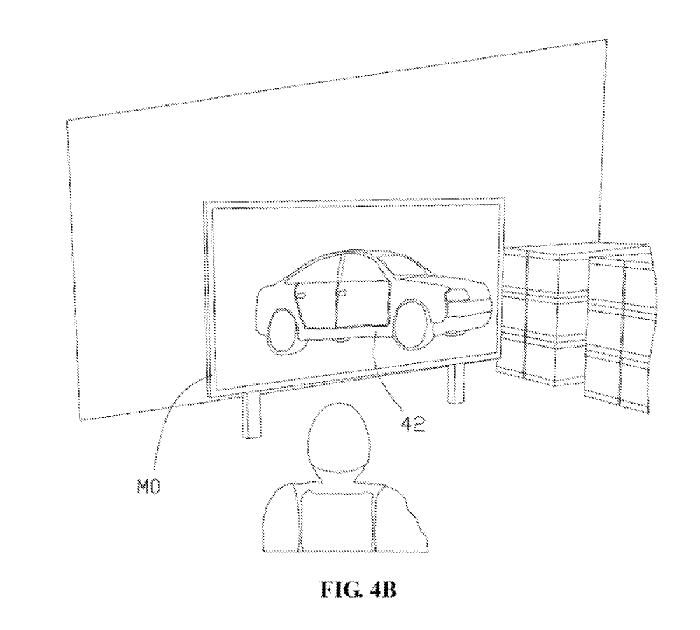

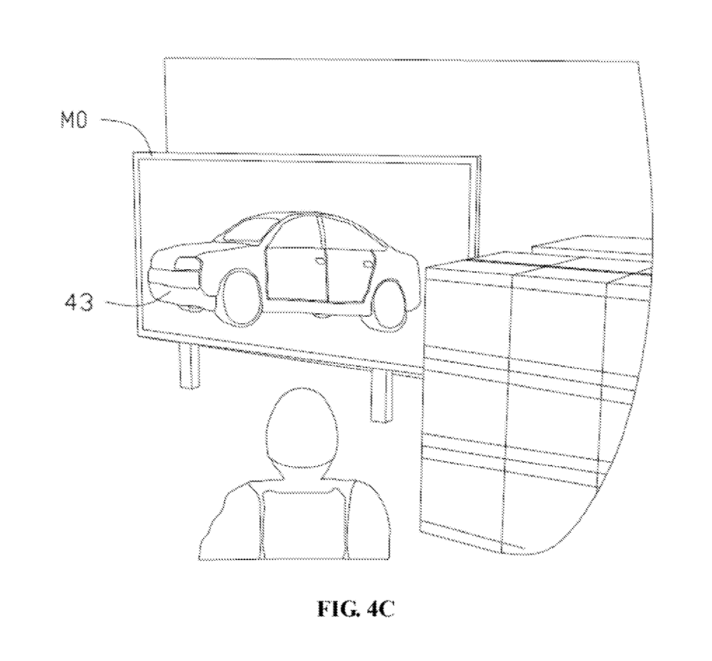

Referring to FIG. 4A, when a frontal image 41 of a car is displayed on the virtual billboard M0, the soldier may be displayed in front of the virtual billboard M0. Referring to FIG. 4B and FIG. 4C, when the user controls the soldier to move towards the left of the current scene, the adjustment module 203 may select a left side image 42 of the car from the image database 210 and display the left side image 42 on the virtual billboard M0. When the user controls the soldier to move towards the right of the current scene, the adjustment module 203 may select a right side image 43 of the car from the image database 210 and display the right side image 43 on the virtual billboard M0. Thus, the display orientation of the car can be adjusted according to movement of the soldier. So that the user can watch advertisement images of the car based on different display orientations by controlling the soldier to move.

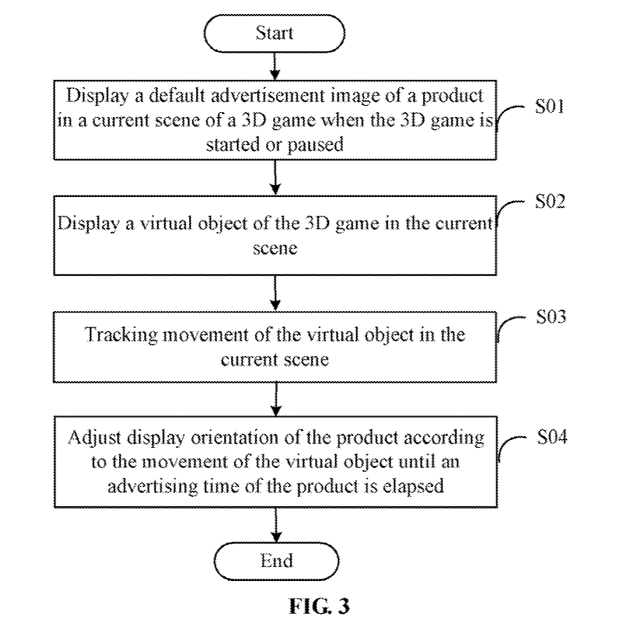

FIG. 3 is a flowchart of one embodiment of an advertisement display method implemented in the electronic device 1 of FIG. 1. Depending on the embodiment, additional blocks may be added, others removed, and the ordering of the blocks, may be changed.

In block S01, the display module 201 displays a default advertisement image of a product (e.g., a car) to be advertised in a current scene of the 3D game 2 when the 3D game 2 is started or paused. The default advertisement image may be obtained from the advertisement images of the image database 210.

In block S02, the display module 201 displays a virtual object, such as an avatar, of the 3D game 2 in the current scene. In the embodiment, the virtual object may be controlled to move in the current scene using a mouse, a keyboard, or a joystick of the device 1.

In block S03, the tracking module 202 tracks movement of the virtual object in the current scene in real-time when the user moves the virtual object in the current scene. In one embodiment, the movement of the avatar is tracked according to control signals input by the user.

In block S04, the adjustment module 203 adjusts a display orientation of the product according to the movement of the virtual object until an advertising time of the product is elapsed. In the embodiment, the display orientation of the product may be adjusted by selecting an advertisement image of the product from the image database 210 according to the movement of the virtual object, and then displaying the selected advertisement image in the current scene.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An advertisement display method implemented in an electronic device, the electronic device being installed with a three dimensional (3D) game, the method comprising:
displaying a default advertisement image of a product in a current scene of the 3D game when the 3D game is started or paused;
displaying a virtual object of the 3D game in the current scene;
tracking movement of the virtual object in the current scene when a user moves the virtual object in the current scene; and
adjusting a display orientation of the product to display advertisements of the product according to the movement of the virtual object until an advertising time of the product is elapsed.

2. The method according to claim 1, wherein the 3D game comprises an image database that stores a plurality of advertisement images of the product based on different display orientations of the product.

3. The method according to claim 2, wherein the default advertisement image is obtained from the advertisement images stored in the image database.

4. The method according to claim 2, wherein the display orientation of the product is adjusted by selecting an advertisement image of the product from the image database according to the movement of the virtual object and displaying the selected advertisement image in the current scene.

5. The method according to claim 2, wherein the advertisement images are uncompressed from the image database to a storage system of the electronic device when the 3D game is installed in the electronic device.

6. An electronic device for advertisement displaying, the electronic device comprising:
at least one processor;
a storage system storing a three dimensional (3D) game; and
one or more programs stored in the storage system and being executable by the at least one processor, the one or more programs comprising:
a displaying module operable to display a default advertisement image of a product in a current scene of the 3D game when the 3D game is started or paused, and display a virtual object of the 3D game in the current scene;
a tracking module operable to track movement of the virtual object in the current scene when a user moves the virtual object in the current scene; and
an adjustment module operable to adjust a display orientation of the product to display advertisements of the product according to the movement of the virtual object until an advertising time of the product is elapsed.

7. The electronic device according to claim 6, wherein the 3D game comprises an image database that stores a plurality of advertisement images of the product based on different display orientations of the product.

8. The electronic device according to claim 7, wherein the default advertisement image is obtained from the advertisement images of the image database.

9. The electronic device according to claim 7, wherein the display orientation of the product is adjusted by selecting an advertisement image of the product from the image database according to the movement of the virtual object and displaying the selected advertisement image in the current scene.

10. The electronic device according to claim 6, wherein the advertisement images are uncompressed from the image database to the storage system when the 3D game is installed in the electronic device.

11. A non-transitory storage medium storing a set of instructions, the set of instructions capable of being executed by a processor of an electronic device to perform an advertisement display method, the electronic device being installed with a three dimensional (3D) game, the method comprising:
displaying a default advertisement image of a product in a current scene of the 3D game when the 3D game is started or paused;
displaying a virtual object of the 3D game in the current scene;
tracking movement of the virtual object in the current scene when a user moves the virtual object in the current scene; and
adjusting a display orientation of the product to display advertisements of the product according to the movement of the virtual object until an advertising time of the product is elapsed.

12. The storage medium as claimed in claim 11, wherein the 3D game comprises an image database that stores a plurality of advertisement images of the product based on different display orientations of the product.

13. The storage medium as claimed in claim 12, wherein the default advertisement image is obtained from the advertisement images of the image database.

14. The storage medium as claimed in claim 12, wherein the display orientation of the product is adjusted by selecting an advertisement image of the product from the image database according to the movement of the virtual object and displaying the selected advertisement image in the current scene.

15. The storage medium as claimed in claim 12, wherein the advertisement images are uncompressed from the image database to a storage system of the electronic device when the 3D game is installed in the electronic device.
